(19) United States
(12) Patent Application Publication
(10) Pub. No.: US 2025/0058385 A1
(43) Pub. Date: Feb. 20, 2025

(54) HANDHELD PUNCH TOOL

(71) Applicant: MILWAUKEE ELECTRIC TOOL CORPORATION, Brookfield, WI (US)

(72) Inventor: Michael R. Rohrer, Milwaukee, WI (US)

(21) Appl. No.: 18/805,815

(22) Filed: Aug. 15, 2024

Related U.S. Application Data
(60) Provisional application No. 63/593,143, filed on Oct. 25, 2023.
(60) Provisional application No. 63/520,446, filed on Aug. 18, 2023.

(51) Int. Cl. B23B 51/04; B23B 45/00

(52) U.S. Cl. CPC B23B 51/0453; B23B 45/00

(57) ABSTRACT

A handheld punch tool including a housing, a motor, and a transmission configured to be driven by a motor shaft. The transmission has a crankshaft and a reciprocating shaft mounted to the crankshaft. The handheld punch tool further includes a bit holder configured to be driven by the crankshaft and to retain a tool bit to form a pilot hole in a workpiece to be cut in response to rotation of the crankshaft and the bit holder. Moreover, the handheld punch tool includes a die holder, a die, and a punch. The die and the die holder define a feed slot therebetween for receiving the workpiece to be cut. The punch is configured to be driven by the reciprocating shaft to reciprocate within the die holder such that at least a portion of each of the die holder, the die, and the punch is insertable into the pilot hole.

### CROSS-REFERENCE TO RELATED APPLICATIONS

This application claims priority to U.S. Provisional Patent Application No. 63/593,143, filed Oct. 25, 2023, and U.S. Provisional Patent Application No. 63/520,446, filed Aug. 18, 2023, the entire contents of both of which are incorporated herein by reference.

### FIELD OF THE INVENTION

The present invention relates to power tools, and more specifically to handheld punch tools.

### BACKGROUND OF THE INVENTION

Handheld reciprocating punch tools, also known as nibblers, operate by rapidly reciprocating a punch to cut through sheet metal, such as ductwork. Although nibblers are generally efficient and accurate tools for cutting through sheet metal, typical nibblers eject numerous small fragments during a cutting operation. These fragments can be sharp and difficult to clean up. In addition, typical nibblers are powered by an AC power source or compressed air, requiring a power cord or air hose that limits access and maneuverability. Finally, typical nibblers can only begin a cut on an edge. In other words, typical nibblers are not able to begin a cut in the middle of a sheet or on a closed duct, for example.

### SUMMARY OF THE INVENTION

The present invention provides, in one aspect, a handheld punch tool. The handheld punch tool includes a housing, a motor supported in the housing, a transmission, a bit holder, a die holder, a die, and a punch. The motor includes a motor shaft. The transmission is supported in the housing and is configured to be driven by the motor shaft. The transmission includes a crankshaft and a reciprocating shaft mounted to the crankshaft. The bit holder is at least partially supported within the housing at an end of the crankshaft opposite from the motor. The bit holder is configured to be driven by the crankshaft. The bit holder is configured to receive a tool bit to form a pilot hole in a workpiece to be cut in response to rotation of the crankshaft and the bit holder. The die holder is coupled to the housing. The die is supported by the die holder. The die and the die holder define a feed slot therebetween for receiving the workpiece to be cut. The punch is configured to be driven by the reciprocating shaft to reciprocate within the die holder such that at least a portion of each of the die holder, the die, and the punch is insertable into the pilot hole formed in the workpiece by the tool bit.

The present invention provides, in another aspect, a handheld punch tool. The handheld punch tool includes a housing, a motor supported in the housing, a transmission, a cut portion, a guard, and a punch. The motor includes a motor shaft rotatable about a first axis. The transmission is supported in the housing and is configured to be driven by the motor shaft. The transmission includes a crankshaft and a reciprocating shaft mounted to the crankshaft. The cut portion is operably coupled to the crankshaft. The cut portion includes a bit holder supported within the housing and is configured to retain a tool bit. The cut portion also includes a blade surrounding the bit holder. The bit holder and the blade are rotatable together about the first axis to form a pilot hole in a workpiece in response to the crankshaft driving the cut portion. The guard is coupled to the bit holder for rotation about the first axis. The guard is movable between a first position, in which the tool bit and the blade are exposed from the guard, and a second position, in which the guard encloses the tool bit and the blade. The punch is configured to be driven by the reciprocating shaft to reciprocate along a second axis perpendicular to the first axis. The punch is insertable into the pilot hole formed in the workpiece by the tool bit and the blade.

The present invention provides, in another aspect, a handheld punch tool. The handheld punch tool includes a housing, a motor supported in the housing, a transmission, a bit holder, a die holder, a clamp assembly, and a punch. The motor includes a motor shaft. The transmission is supported in the housing and is configured to be driven by the motor shaft. The transmission includes a crankshaft and a reciprocating shaft mounted to the crankshaft. The bit holder is at least partially supported within the housing at an end of the crankshaft opposite from the motor. The bit holder is configured to be driven by the crankshaft. The bit holder is configured to retain a tool bit to form a pilot hole in a workpiece in response to rotation of the crankshaft. The die holder is coupled to the housing. The die holder is configured to be oriented in one of a plurality of rotational orientations relative to the housing. The clamp assembly is supported within the die holder and operably coupled to the reciprocating shaft for reciprocation. The punch is removably coupled to clamp assembly by a fastening member to reciprocate therewith. The punch is insertable into the pilot hole formed in the workpiece by the tool bit.

### BRIEF DESCRIPTION OF THE DRAWINGS

FIG. 1 is a perspective view of a punch tool according to an embodiment of the invention.

FIG. 2 is a cross-sectional view of the punch tool of FIG. 1 taken along line 2-2.

FIG. 3 is a zoomed-in view of the cross-sectional view of the punch tool of FIG. 2.

FIG. 4 is a bottom perspective view of a portion of a cutting head for the punch tool of FIG. 1.

FIG. 5 is a cross-sectional view of a portion of the punch tool of FIG. 1 taken along line 5-5.

FIG. 6A is a front view of a portion of the punch tool of FIG. 1.

FIG. 6B is a front perspective view of a portion of the punch tool of FIG. 1.

FIG. 7A is a plan view of a portion of the punch tool of FIG. 1 with an adjustable guard mechanism in a first position.

FIG. 7B is a plan view of a portion of the punch tool of FIG. 1 with the adjustable guard mechanism in a second position.

FIG. 8 is a perspective view of a portion of a guard for the adjustable guard mechanism of FIG. 7A.

FIG. 9 is a plan view of another portion of the punch tool.

FIG. 10 is a perspective view of a punch tool according to another embodiment of the disclosure.

FIG. 11 is a cross-sectional view of the punch tool of FIG. 10 taken along line 11-11 in FIG. 10.

FIG. 12 is an enlarged view of a portion of the punch tool of FIG. 11.

FIG. 13 is a perspective view of the punch tool of FIG. 1 illustrating a cutting operation of the punch tool to create a pilot hole in a workpiece.

FIG. 14 is a perspective view of the punch tool illustrating a punching operation at the pilot hole of FIG. 13.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

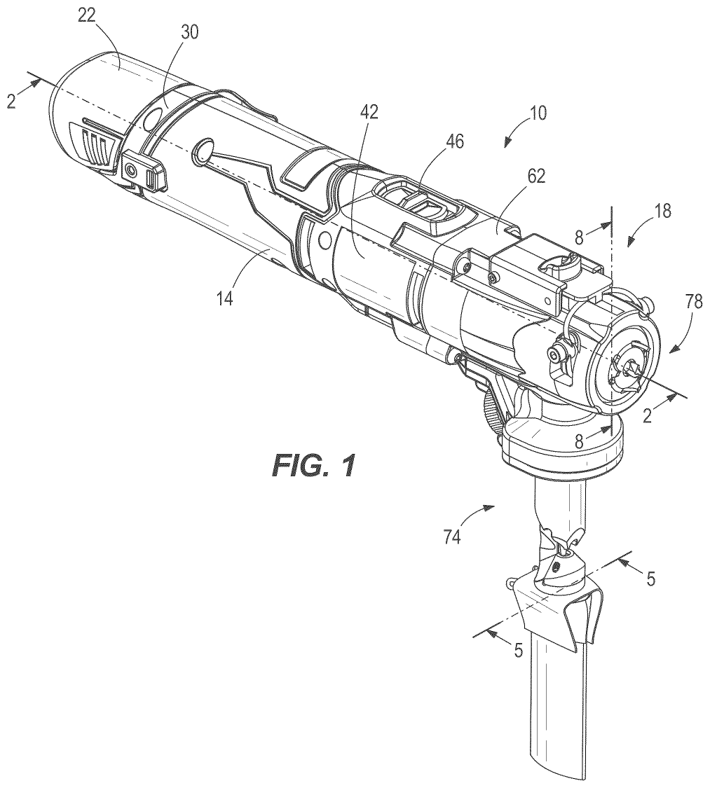

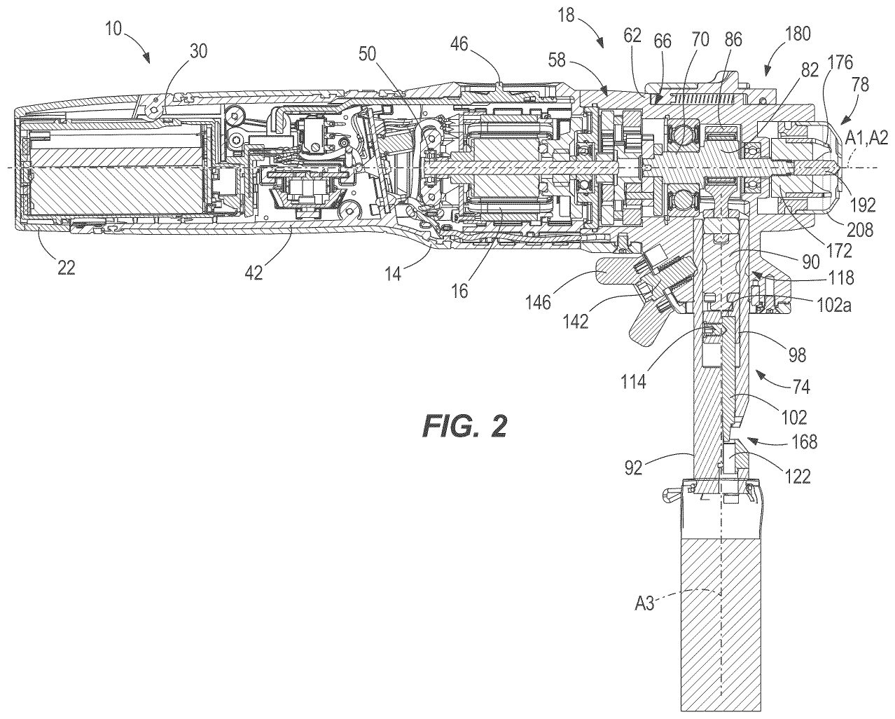

FIGS. 1-2 illustrate a handheld punch tool or nibbler 10 including a housing 14, an electric motor 16 (FIG. 2) supported within the housing 14, a cutting head 18 positioned at a front end of the housing 14, and a battery pack 22 for supplying power to the motor 16 for operating the cutting head 18. The illustrated battery pack 22 is a rechargeable battery pack with a plurality of lithium-based cells. The battery pack 22 may have a nominal output voltage of about 12 Volts. In other embodiments, the battery pack 22 may have other nominal output voltages (e.g., about 18 Volts or more). The features and advantages of the nibbler 10 according to the present disclosure may also be applied to corded nibblers or pneumatic nibblers, however.

With reference to FIG. 2, the housing 14 defines a first axis or housing axis A1, which is a longitudinal axis that extends centrally through the housing 14 along its length. The battery pack 22 is partially insertable into a battery receptacle 30 located at a rear portion of the housing 14, opposite the cutting head 18. In the illustrated embodiment, the battery pack 22 is insertable into the battery receptacle 30 along the first axis A1 to couple the battery pack 22 to the battery receptacle 30. This arrangement provides the nibbler 10 with a compact, in-line arrangement that facilitates use of the nibbler 10 in tight spaces.

The illustrated housing 14 includes a handle portion 42 (i.e., a portion of the housing 14 configured to be grasped by an operator during operation of the nibbler 10) having a generally cylindrical shape. The housing axis A1 extends centrally through the handle portion 42. However, the housing 14 may have a variety of other constructions such that the housing axis A1 may not extend through the handle portion 42. For example, the housing 14 may be generally ‘L’ or ‘T’ shaped with the handle portion 42 formed as a pistol grip. In such embodiments, the housing axis A1 may not extend through the handle portion 42 but rather may extend through another portion of the housing 14 containing the motor 16.

An on/off switch 46 is located on the handle portion 42 for selectively electrically connecting the motor 16 and the battery pack 22 to provide DC power to the motor 16. The motor 16 is a brushless DC motor in the illustrated embodiment and has a motor shaft 50 (e.g., part of a rotor assembly) that is rotatable about a second axis or motor axis A2. The motor 16 is oriented such that the motor axis A2 is coaxial with the housing axis A1. As such, relationships described herein with reference to the motor axis A2 are equally applicable to the housing axis A1, and vice versa. However, in other embodiments, the motor axis A2 and the housing axis A1 may not be coaxial.

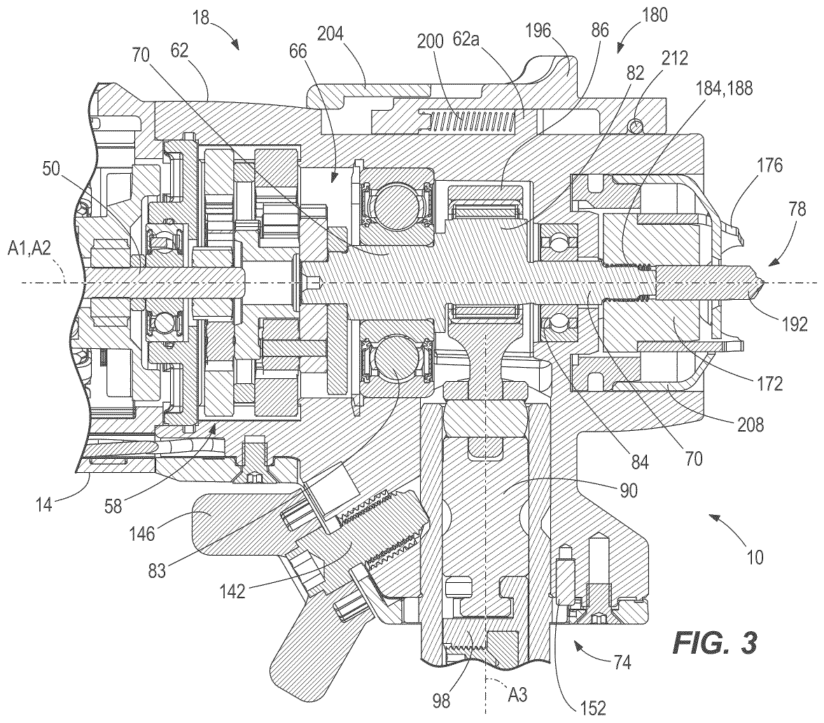

With reference to FIGS. 2 and 3, the nibbler 10 includes a drive assembly 58 coupled to the motor shaft 50 and contained at least partially within a front or drive casing 62 of the cutting head 18. The drive assembly 58 includes a transmission 66 (e.g., a single or multi-stage planetary transmission, which may be shiftable to provide multiple speed/torque settings in some embodiments) that receives torque from the motor shaft 50 and an output shaft 70 driven by the transmission 66. The transmission 66 and the output shaft 70 are coaxial with the motor axis A2 in the illustrated embodiment; however, in other embodiments, the transmission 66 and/or the output shaft 70 may be oriented in other ways. In yet other embodiments, the output shaft 70 may be directly driven by the motor shaft 50. The output shaft 70 may also be referred to as a crankshaft.

The cutting head 18 includes a punch portion 74 and a cut portion 78. Each of the punch portion 74 and the cut portion 78 is coupled to and is configured to be driven by the output shaft 70. The punch portion 74 is coupled to an eccentric portion 82 of the output shaft 70 and extends from the output shaft 70 in a direction perpendicular to the motor axis A2. Specifically, the punch portion 74 extends along a third axis A3 that is perpendicular to the first and second axes A1, A2. The orientation of the third axis A3 may vary in other embodiments. The eccentric portion 82 of the output shaft 70 is positioned between a rearward bearing 83 and a forward bearing 84 that support rotation of the output shaft 70 (FIG. 3). As such, the third axis A3 extends between the bearings 83, 84. The cut portion 78 is disposed at an end of the output shaft 70 and extends along a direction parallel to the motor axis A2.

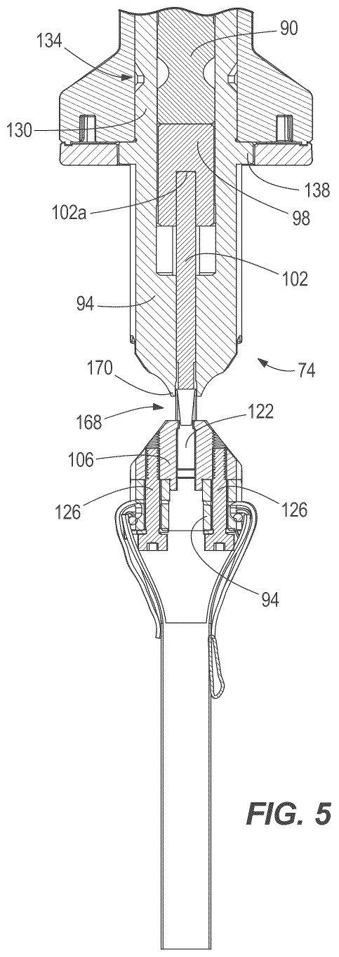

As illustrated in FIGS. 2, 4, and 5, the punch portion 74 of the cutting head 18 includes a yoke 86, a drive rod 90, a die holder 94, a clamp assembly 98, a punch 102, and a die 106. The yoke 86 surrounds the eccentric portion 82 of the output shaft 70 and couples the punch portion 74 to the output shaft 70. The opposite end of the yoke 86 is pivotally coupled to the drive rod 90. Rotation of the output shaft 70 thus causes reciprocation of the yoke 86 and the drive rod 90 along third axis A3 (FIG. 2). As such, the yoke 86 may also be referred to as a reciprocating shaft.

The drive rod 90 is received within an upper portion of the die holder 94 that is coupled to the drive casing 62. The die holder 94 also houses the clamp assembly 98 coupled to the drive rod 90 opposite the yoke 86. The clamp assembly 98 receives a first end 102a of the punch 102. A fastening member or set screw 114 (FIG. 2) engages a circumferential groove in the punch 102 to removably couple the punch 102 to the clamp assembly 98 for reciprocating therewith. The punch 102 can thus be conveniently removed and replaced when worn, or to substitute the punch 102 for a punch having a different size or geometry.

The die 106 defines a passageway 122 through which the punch 102 reciprocates in response to reciprocation of the drive rod 90 and clamp assembly 98. The die 106 is removably coupled to the die holder 94 by second set screws 126, which, in the illustrated embodiment, are accessible from a bottom end of the die holder 94. Thus, the die 106, like the punch 102, can be conveniently removed and replaced when worn, or to substitute the die 106 for a die having a different size or geometry.

With continued reference to FIGS. 2, 4 and 5, the die holder 94 in the illustrated embodiment includes a main body 130, an annular groove 134 recessed into the main body 130, and a flange 138 extending radially outwardly from the main body 130. The annular groove 134 receives the distal end of a set screw 142 (FIG. 2), which, in the illustrated embodiment, includes a knob 146 to facilitate hand adjustment of the set screw 142. The set screw 142 is oriented at an oblique angle relative to the third axis A3, such that tightening the set screw 142 exerts both an axial and radial compressive force on the groove 134 of the main body 130 to secure the die holder 94 to the drive casing 62.

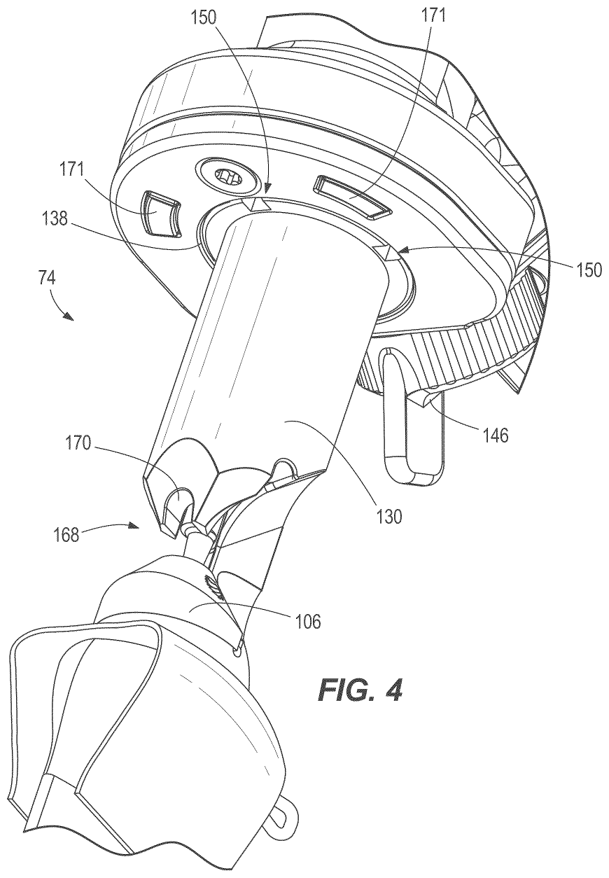

In the illustrated embodiment, the flange 138 of the die holder 94 includes a plurality of notches 150 extending radially inwardly from an outer circumferential edge of the flange 138 (FIG. 4). The notches 150 are configured to receive a pin or detent 152 (FIG. 3) extending from the drive casing 62 to define a plurality of rotational orientations of the die holder 94 relative to the drive casing 62. That is, loosening the set screw 142 allows the die holder 94 to be rotated relative to the drive casing 62, and each of the respective notches 150 can be aligned with the pin or detent 152 to set the die holder 94 in a predetermined rotational position. In the illustrated embodiment, the flange 138 includes four notches 150, each offset by 90 degrees, thereby providing the die holder 94 with four predetermined rotational positions. In other embodiments, the flange 138 may include any other number of notches 150 to provide a greater or lesser number of predetermined rotational positions.

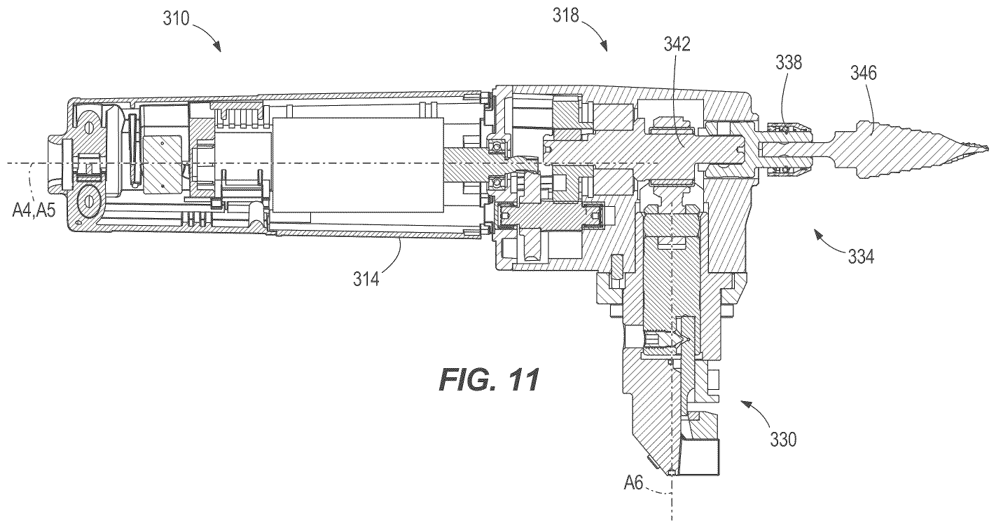

A feed slot 168 is defined between the die 106 and an opposing upper wall 170 of the die holder 94 (FIG. 4). Sheet material to be cut is fed into the feed slot 168 during operation and into the path of the reciprocating punch 102. By adjusting the orientation of the die holder 94 as described above, the feed slot 168 is repositionable to permit a user to hold the nibbler 10 in a desired orientation while guiding it along a cut line on a workpiece 5 (FIG. 11).

With continued reference to FIG. 4, the nibbler 10 further includes a plurality of lighting elements 171 configured to illuminate the punch portion 74 of the cutting head 18. Specifically, the lighting elements 171 are supported in the housing 14 of the nibbler 10 in an orientation that faces the die 106 such that the lighting elements 171 are configured to emit light in a direction extending at least partially along the third axis A3.

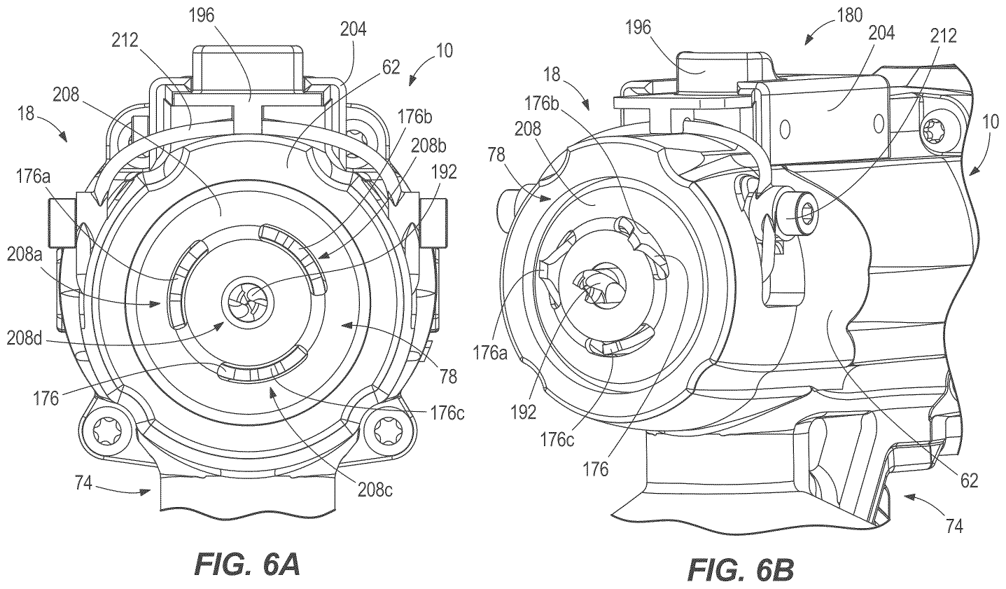

As illustrated in FIGS. 3, 6A, and 6B, the cut portion 78 includes a bit holder 172, an outer blade 176, and an adjustable guard mechanism 180 for selectively covering the outer blade 176. In the illustrated embodiment, the bit holder 172 is an arbor. In some embodiments, the cut portion 78 may not include the adjustable guard mechanism 180. The arbor 172, the outer blade 176, and at least a portion of the adjustable guard mechanism 180 are configured to rotate together as the cut portion 78 is driven by the output shaft 70. The arbor 172 is aligned within the nibbler 10 such that the first and second axes A1, A2 extend through each of the battery pack 22 (FIG. 2), the motor 16 (FIG. 2), and the arbor 172. One side of the arbor 172 is coupled to the end of the output shaft 70. Specifically, in the illustrated embodiment, the end of the output shaft 70 includes male threads 184 that threadedly couple to female threads 188 in the arbor 172. In other embodiments, the output shaft 70 may have a hexagonal end, or a hex shaft, that is received in a hexagonal receptacle on the arbor 172 to releasably couple the output shaft 70 to the arbor 172. In further embodiments, other releasable coupling means between the output shaft 70 and the arbor 172 may be considered. On a side of the arbor 172 opposite the output shaft 70, a tool bit 192 is coupled to the arbor 172. Specifically, the tool bit 192 may be welded to the arbor 172. In the illustrated embodiment, the tool bit 192 is a drill bit. However, the arbor 172 may be coupled with various other tool bits, such as a stepped drill bit, a hole saw bit, and other similar bits. In some embodiments, the tool bit 192 may be releasably coupled to the arbor 172 such that different types of tool bits may be interchangeably used with the punch tool 10. When the tool bit 192 is coupled in the arbor 172, the punch tool 10 is configured to perform a cutting operation on a workpiece 5 to form a pilot hole 5a in the workpiece 5 (e.g., as illustrated in FIG. 11), as will be described in more detail.

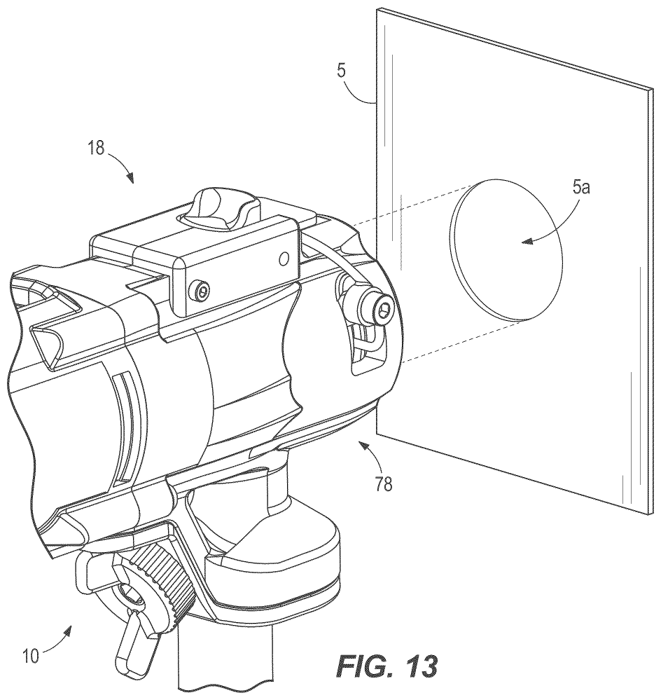

The outer blade 176 surrounds the arbor 172 and includes three blades 176a-176c that protrude from apertures 208a-208c (FIG. 6A) in the adjustable guard mechanism 180. In some embodiments, the outer blade 176 may include fewer or more blades 176a-176c. For example, the outer blade 176 may include two blades, four blades, or five or more blades. The outer blade 176 may protrude a distance from the drive casing 62 that is less than the tool bit 192 such that the tool bit 192 is operable to cut the workpiece 5 (FIG. 13) without engaging the blades 176a-176c with the workpiece 5 (FIG. 13). However, if the blades 176a-176c are engaged with the workpiece 5 (FIG. 13), the blades 176a-176c may create a larger hole in the workpiece 5 (FIG. 13) than through use of the tool bit 192 alone. As such, when the tool bit 192 and the outer blade 176 are used together, the cut portion 78 of the cutting head 18 may function substantially similarly as a hole saw.

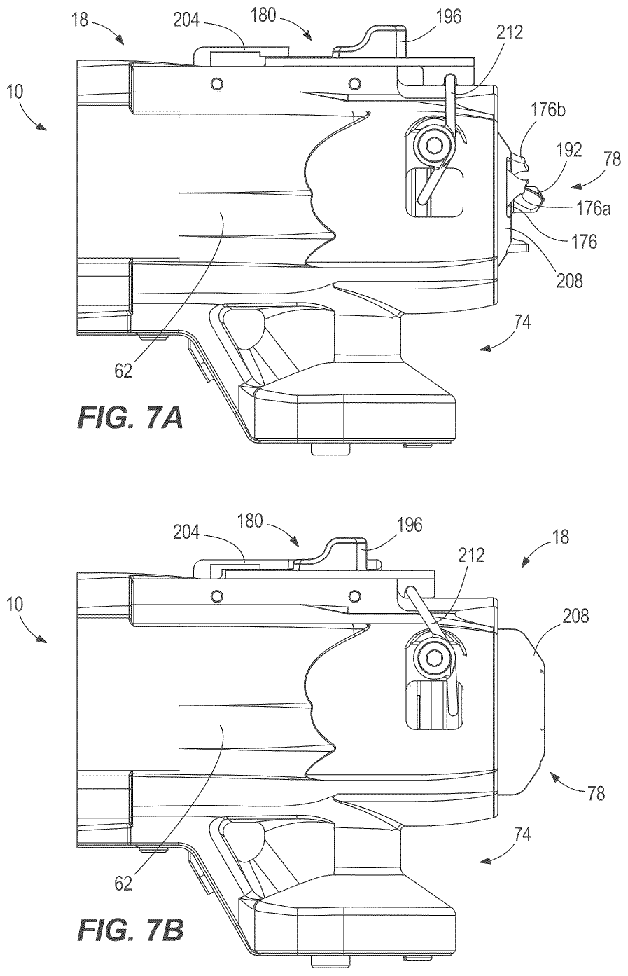

With reference to FIGS. 3, 7A, and 7B, the adjustable guard mechanism 180 includes a guard slide actuator 196, a spring 200 that biases the guard slide actuator 196, a slide lock 204, and a guard 208. The guard slide actuator 196 is positioned on a top side of the drive casing 62. That is, the guard slide actuator 196 is positioned on a side of the drive casing 62 opposite the die holder 94 and die 106. The guard slide actuator 196 is configured to slide along the top side of the drive casing 62 to move the adjustable guard mechanism 180 between a cut position (FIG. 7A) and a guard position (FIG. 7B). In the cut position (FIG. 7A), the guard slide actuator 196 is in a forward-most position relative to the drive casing 62. In the guard position (FIG. 7B), the guard slide actuator 196 is in a rearward-most position relative to the drive casing 62. In some embodiments, the adjustable guard mechanism 180 may not include a guard slide actuator 196. In such embodiments, the guard 208 may be directly engaged by a user to move the guard 208 and place the adjustable guard mechanism 180 in the cut position and in the guard position.

The spring 200 biases the guard slide actuator 196 against the drive casing 62. Specifically, the drive casing 62 includes a protrusion 62a (FIG. 3), and the spring 200 has an end positioned at the protrusion 62a to bias the guard slide actuator 196 rearwardly. As such, the spring 200 biases the guard slide actuator 196 to the rearward-most position relative to the drive casing 62 such that the spring 200 biases the adjustable guard mechanism 180 to the guard position (FIG. 7B). The guard slide actuator 196 may be pushed against the bias of the spring 200 in the forward direction to move the adjustable guard mechanism 180 to the cut position (FIG. 7A). As the guard slide actuator 196 moves the adjustable guard mechanism 180 to the cut position, the guard slide actuator 196 may be engaged with the slide lock 204 to hold the adjustable guard mechanism 180 in the cut position. In other embodiments, the orientation of the protrusion 62a and the spring 200 may be reversed such that the spring 200 biases the guard slide actuator 196 to the forward-most position.

In some embodiments, the adjustable guard mechanism 180 may not include the spring 200, and may instead include, for example, one or more pins or detents for holding the guard slide actuator 196 in either the cut position or the guard position. As such, the adjustable guard mechanism 180 may be freely slidable relative to the housing 14 to move the guard 208 between the cut position and the guard position without the influence of a biasing member such as the spring 200.

The guard 208 is substantially cylindrical and is coupled to the arbor 172 for rotation with the arbor 172. The guard 208 extends forward of the arbor 172 and defines apertures 208a-208d (FIG. 6A) for the tool bit 192 and the outer blade 176 to extend through. As such, each blade 176a-176c of the outer blade 176 extends through a corresponding outer aperture 208a-208c (FIG. 6A), and the tool bit 192 extends through a central aperture 208d. The guard 208 is also coupled to the guard slide actuator 196 via a wire lever 212. The wire lever 212 translates rearward movement of the guard slide actuator 196 into forward movement of the guard 208 and translates forward movement of the guard slide actuator 196 into rearward movement of the guard 208. As such, when guard slide actuator 196 is moved to the forward-most position to place the adjustable guard mechanism 180 in the cut position, the guard 208 moves rearwardly such that the tool bit 192 and the outer blade 176 extend through and are exposed from the guard 208. When the guard slide actuator 196 is moved to the rearward-most position to place the adjustable guard mechanism 180 in the guard position, the guard 208 moves forwardly such that the guard 208 substantially encloses the tool bit 192 and the outer blade 176. That is, the tool bit 192 and the outer blade 176 are not exposed from the guard 208 when the adjustable guard mechanism 180 is in the guard position. In some embodiments, the guard 208 may be coupled to the guard slide actuator 196 via a plastic lever (e.g., an injection molded lever) in place of the wire lever 212. In the illustrated embodiment, the guard 208 is configured to travel 9 mm as the guard slide actuator 196 moves between the forward-most and rearward-most positions. In other embodiments, the guard 208 may travel more or less. In the illustrated embodiment, with the adjustable guard mechanism 180 in the guard position, a front end of the guard 208 is positioned 20 mm in front of the punch portion 74 in a direction extending along the first and second axes A1, A2. In other embodiments, the guard 208 may be positioned closer or further away from the punch portion 74.

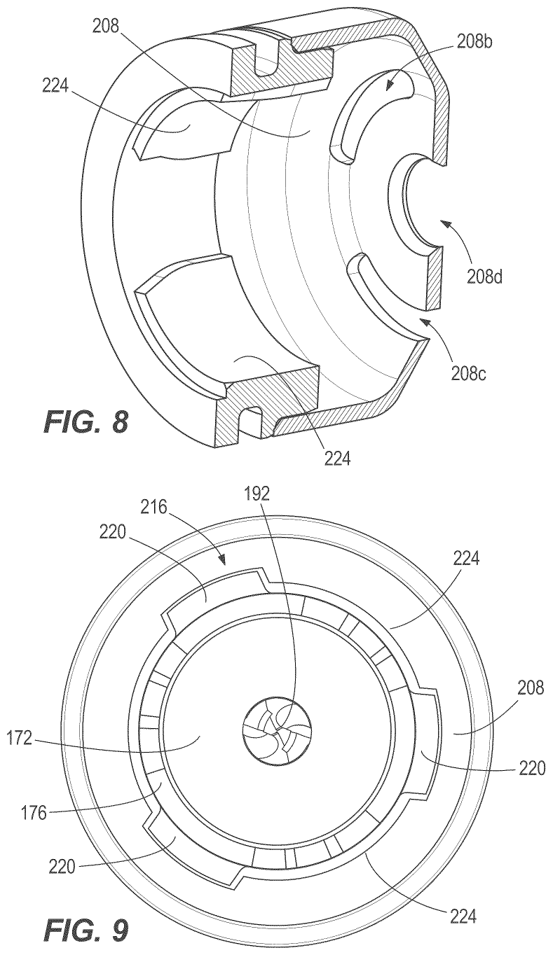

With reference to FIGS. 8 and 9, the cut portion 78 further includes an alignment mechanism 216 that inhibits the outer blade 176 from becoming misaligned with the guard 208. The alignment mechanism 216 includes a plurality of arbor protrusions 220 on the arbor 172 and a plurality of guard protrusions 224 on the guard 208. The arbor protrusions 220 are equally spaced around the circumference of the arbor 172 and extend from an outer surface of the arbor 172 toward the guard 208. The guard protrusions 224 are equally spaced around the circumference of the guard 208 and extend from an inner surface of the guard 208 toward the arbor 172. Each of the arbor protrusions 220 is spaced between two adjacent guard protrusions 224 to inhibit rotation of the arbor 172 relative to the guard 208. In other words, the arbor 172 and the guard 208 are constrained for rotation together due, at least in part, to the arbor protrusions 220 and the guard protrusions 224. Because the outer blade 176 and the arbor 172 are unitized for co-rotation, the positioning of the arbor protrusions 220 and guard protrusions 224 inhibits rotation of the outer blade 176 relative to the guard 208 even when the adjustable guard mechanism 180 is in the guard position. Therefore, the alignment mechanism 216 advantageously enables the adjustable guard mechanism 180 to move between the cut position and the guard position without the blades 176a-176c (FIG. 6A) becoming misaligned with the respective apertures 208a-208c defined in the guard 208.

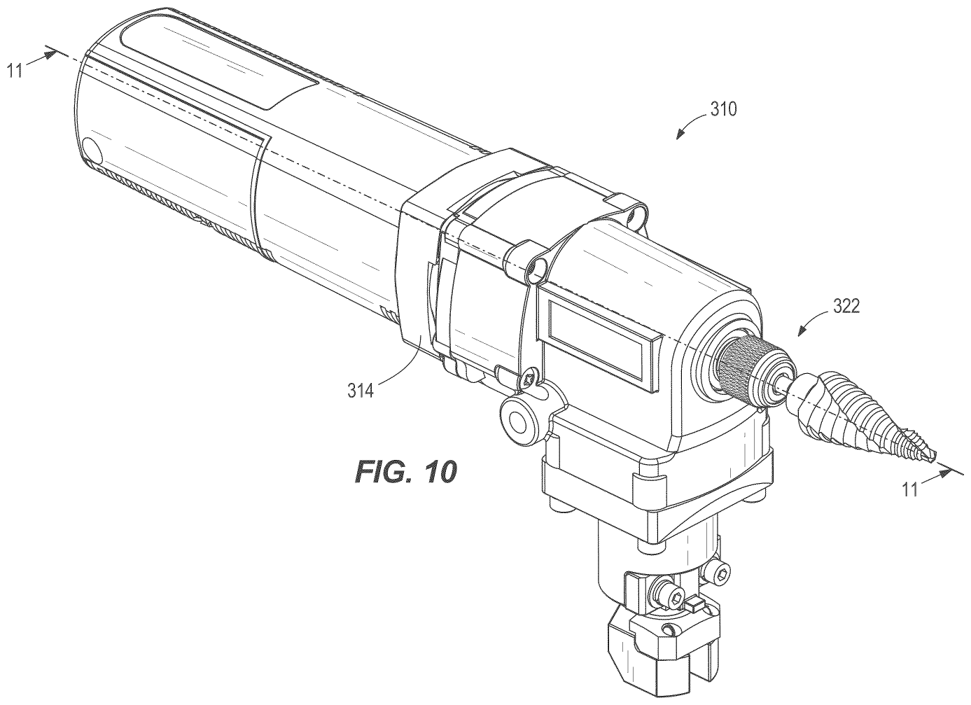

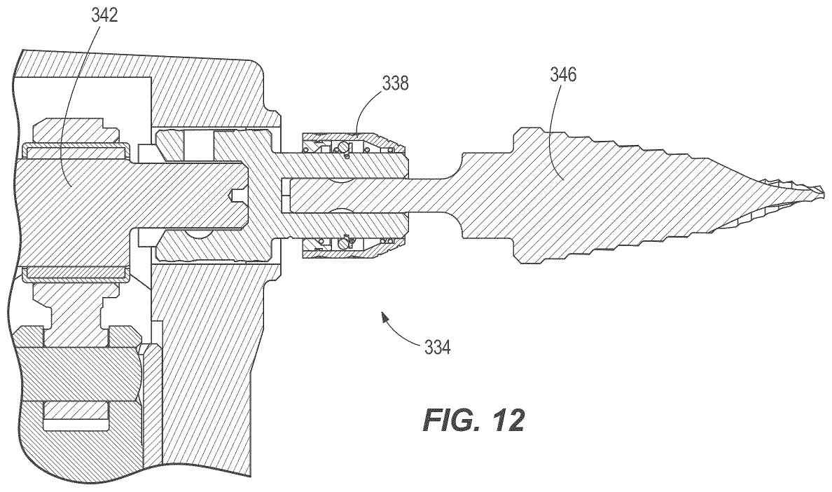

FIGS. 10-12 illustrate a handheld punch tool or nibbler 310 according to another embodiment of the disclosure. The nibbler 310 may be substantially similar to the nibbler 10 of FIG. 1, except for the differences described herein. The nibbler 310 includes a housing 314 that defines a first axis A4, and an electric motor 318 that is configured to rotate about a second axis A5, a cutting head 322 coupled to a front portion of the housing 314. In the illustrated embodiment, the first axis A4 and the second axis A5 are the same. The cutting head 322 extends partially in a direction that extends parallel to the first and second axes A4, A5 and partially along a third axis A6 that is perpendicular to the first and second axes A4, A5.

The cutting head 322 includes a punch portion 330 and a cut portion 334. The punch portion 330 extends along the third axis A6. The cut portion 334 extends in a direction parallel to the first and second axes A4, A5. The cut portion 334 includes a bit holder 338 that extends forward of the housing 314 such that the bit holder 338 is not completely surrounded by the housing 314 of the nibbler 310. That is, the bit holder 338 protrudes from the housing 314. In the illustrated embodiment, the bit holder 338 is a chuck. The chuck 338 is coupled to and is configured to be driven by an end of an output shaft 342. A tool bit 346 is insertable into the chuck 338. In the illustrated embodiment, the tool bit 346 is a stepped drill bit. The chuck 338 may include a detent mechanism or another similar retaining means for securing the tool bit 346 within the chuck 338. When the tool bit 346 is coupled in the chuck 338, the punch tool 310 is configured to perform a cutting operation on a workpiece to form a pilot hole in the workpiece.

Operation of the nibbler 10 is described below with respect to the nibbler 10 of FIGS. 1-9. However, operation of the nibbler 310 of FIGS. 10-12 may be substantially similar to the nibbler 10. With reference to FIGS. 2, 7A, 7B and 13, to use the nibbler 10, an operator may move the adjustable guard mechanism 180 from the guard position (FIG. 7B) to the cut position (FIG. 7A) by moving the guard slide actuator 196 against the bias of the spring 200. The guard slide actuator 196 may then be held in place by the slide lock 204 such that the adjustable guard mechanism 180 does not inadvertently or unintentionally move back to the guard position. In the cut position, the guard 208 is oriented such that the tool bit 192 and the outer blade 176 are exposed from the guard 208. The operator may then depress the switch 46 to activate the motor 16, which continuously supplies torque to the drive assembly 58 via the motor shaft 50 (FIG. 2). The motor shaft 50 drives the output shaft 70 via the transmission 66. As the output shaft 70 rotates, the output shaft 70 drives the cut portion 78 of the cutting head 18 such that the tool bit 192, the outer blade 176 and the guard 208 all rotate together. The nibbler 10 may then be brought into engagement with the workpiece 5 such that the cut portion 78 of the cutting head 18 forms the pilot hole 5a.

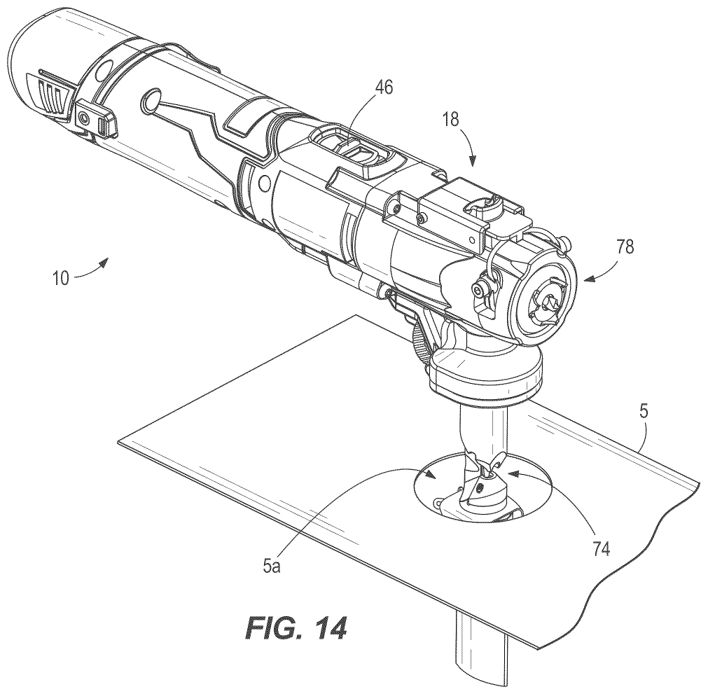

With reference to FIGS. 2, 5, and 14, once the pilot hole 5a is created in the work piece, the cut portion 78 of the cutting head 18 may be pulled out of the pilot hole 5a, and the punch portion 74 of the cutting head 18 may be inserted into the pilot hole 5a. The operator may return the adjustable guard mechanism 180 to the guard position (FIG. 7B) between creating the pilot hole 5a and inserting the punch portion 74 into the pilot hole 5a to cover the outer blade 176. As the output shaft 70 rotates, the output shaft 70 also drives the drive rod 90 of the cutting head 18 to reciprocate along the third axis A3 due to the motion of the yoke 86. The drive rod 90 reciprocates the clamp assembly 98, which in turn reciprocates the punch 102. With the punch portion 74 inserted into the pilot hole 5a, the operator may guide the punch portion 74 onto the surface of the workpiece 5. As the workpiece 5 enters the feed slot 168 in the die holder 94, the reciprocating punch 102 repeatedly and incrementally shears small pieces of the workpiece against the die 106 to create an elongated cut. As such, the cut portion 78 of the cutting head 18 enables the operator to start the punching operating at locations on the workpiece 5 other than at the outer edges of the workpiece 5.

Although the disclosure has been described in detail with reference to certain preferred embodiments, variations and modifications exist within the scope and spirit of one or more independent aspects of the disclosure as described.

Various features of the present disclosure are set forth in the following claims.

What is claimed is:

1. A handheld punch tool comprising:
a housing;
a motor supported in the housing, the motor including a motor shaft;
a transmission supported in the housing and configured to be driven by the motor shaft, the transmission including a crankshaft and a reciprocating shaft mounted to the crankshaft;
a bit holder at least partially supported within the housing at an end of the crankshaft opposite from the motor, the bit holder configured to be driven by the crankshaft, the bit holder configured to retain a tool bit to form a pilot hole in a workpiece to be cut in response to rotation of the crankshaft and the bit holder;
a die holder coupled to the housing;
a die supported by the die holder, the die and the die holder defining a feed slot therebetween for receiving the workpiece to be cut; and
a punch configured to be driven by the reciprocating shaft to reciprocate within the die holder such that at least a portion of each of the die holder, the die, and the punch is insertable into the pilot hole formed in the workpiece by the tool bit.

2. The handheld punch tool of claim 1, wherein the tool bit is a hole saw.

3. The handheld punch tool of claim 1, wherein the tool bit is a stepped drill bit.

4. The handheld punch tool of claim 1, further comprising a battery pack received within a battery receptacle defined in the housing, wherein the battery pack, the motor, and the bit holder are aligned along an axis that extends through each of the battery pack, the motor, and the bit holder.

5. The handheld punch tool of claim 1, wherein the transmission further includes a first bearing and a second bearing that support the crankshaft, and wherein the reciprocating shaft is mounted to the crankshaft at a location between the first bearing and the second bearing.

6. The handheld punch tool of claim 1, wherein the housing includes a front casing, and wherein the bit holder is positioned within the front casing such that the tool bit extends at least partially into the front casing when the tool bit is inserted into the bit holder.

7. A handheld punch tool comprising:
a housing;
a motor supported in the housing, the motor including a motor shaft rotatable about a first axis;
a transmission supported in the housing and configured to be driven by the motor shaft, the transmission including a crankshaft and a reciprocating shaft mounted to the crankshaft;
a cut portion operably coupled to the crankshaft, the cut portion including a bit holder supported within the housing and configured to retain a tool bit, and a blade surrounding the bit holder, the bit holder and the blade are rotatable together about the first axis to form a pilot hole in a workpiece in response to the crankshaft driving the cut portion;
a guard coupled to the bit holder for rotation about the first axis, the guard movable between a first position, in which the tool bit and the blade are exposed from the guard, and a second position, in which the guard encloses the tool bit and the blade; and
a punch configured to be driven by the reciprocating shaft to reciprocate along a second axis perpendicular to the first axis, the punch is insertable into the pilot hole formed in the workpiece by the tool bit and the blade.

8. The handheld punch tool of claim 7, further comprising a guard actuator operably coupled to the guard, the guard actuator configured to slide along the housing to move the guard between the first position and the second position.

9. The handheld punch tool of claim 8, further comprising a spring biasing the guard actuator relative to the housing such that the guard is biased into the second position.

10. The handheld punch tool of claim 8, wherein the guard actuator is coupled to the guard by a wire lever.

11. The handheld punch tool of claim 7, wherein the cut portion includes an alignment mechanism configured to inhibit the blade from becoming misaligned with the guard.

12. The handheld punch tool of claim 11, wherein the alignment mechanism includes a first plurality of protrusions on the bit holder and a second plurality of protrusions on the guard, and wherein the first plurality of protrusions and the second plurality of protrusions inhibit rotation of the blade relative to the guard.

13. The handheld punch tool of claim 7, wherein the guard defines a plurality of apertures through which the tool bit and the blade extend.

14. The handheld punch tool of claim 7, further comprising a battery pack received within a battery receptacle defined in the housing.

15. A handheld punch tool comprising:
a housing;
a motor supported in the housing, the motor including a motor shaft;
a transmission supported in the housing and configured to be driven by the motor shaft, the transmission including a crankshaft and a reciprocating shaft mounted to the crankshaft;
a bit holder at least partially supported within the housing at an end of the crankshaft opposite from the motor, the bit holder configured to be driven by the crankshaft, the bit holder configured to retain a tool bit to form a pilot hole in a workpiece in response to rotation of the crankshaft;
a die holder coupled to the housing, the die holder configured to be oriented in one of a plurality of rotational orientations relative to the housing;
a clamp assembly supported within the die holder and operably coupled to the reciprocating shaft for reciprocation; and
a punch removably coupled to the clamp assembly by a fastening member to reciprocate therewith, the punch is insertable into the pilot hole formed in the workpiece by the tool bit.

16. The handheld punch tool of claim 15, wherein the die holder includes a plurality of notches configured to receive a detent extending from the housing to define the plurality of rotational orientations.

17. The handheld punch tool of claim 16, further comprising a set screw for securing the die holder to the housing when the detent is received within any of the notches.

18. The handheld punch tool of claim 15, further comprising a battery pack received within a battery receptacle defined in the housing, wherein the battery pack, the motor, and the bit holder are aligned along a first axis that extends through each of the battery pack, the motor, and the bit holder.

19. The handheld punch tool of claim 18, wherein the reciprocating shaft is reciprocated along a second axis perpendicular to the first axis.

20. The handheld punch tool of claim 19, wherein the die holder is secured to the housing by a set screw oriented at an oblique angle relative to the second axis.
